(19) United States
(12) Patent Application Publication
(10) Pub. No.: US 2004/0124323 A1
(43) Pub. Date: Jul. 1, 2004

(54) Simple assembly banana hanger

(76) Inventor: Matthew J. Kamenstein, New York, NY (US)

Correspondence Address: Buchanan Ingersoll P.C., Eleven Penn Center, 1835 Market Street, 14th Floor, Philadelphia, PA, 19103-2985, US

(21) Appl. No.: 10/335,541

(22) Filed: Dec. 31, 2002

(51) Int. Cl. F16L 3/00

(52) U.S. Cl. 248/121; 248/176.1

(57) ABSTRACT

A banana hanger comprising a base member, supporting member, and hanging member wherein the base member contains a dovetail notch and the supporting member contains a connector piece that slideably connects into the dovetail notch such that assembly and disassembly by the end user is easily completed without the use of tools or additional hardware.

### FIELD OF THE INVENTION

The present invention relates generally to the field of banana hangers, and more specifically to a banana hanger having a base member slideably connected to a supporting member such that no additional hardware or tools are required to assemble or disassemble it.

### BACKGROUND

Banana hangers typically rest on a surface such as a table or counter and suspend a bunch of bananas above this surface. This generally results in all the bananas ripening at the same rate and prevents damage to portions of the banana resting on the surface. In addition, such hangers provide an aesthetically pleasing visual presentation of the fruit.

A number of design patents and utility patents for banana hangers are known. For example, U.S. Pat. No. D367,153 to Sturm, U.S. Pat. No. D369,482 to McArdle, and U.S. Pat. No. D419,034 to Sturm present designs for banana hangers involving a support arm connected to a base. Similarly, U.S. Pat. No. 5,826,843 to Sturm and U.S. Pat. No. 4,141,529 to Casutt each provide an apparatus for hanging bananas. As illustrated in the references, banana hangers come in one or more than one piece, in the latter case requiring assembly by the end user. For example, U.S. Pat. No. 4,141,529 to Casutt describes a one-piece banana hanger which is not self-contained, but rather must be hung from some other, unspecified suspension point. U.S. Pat. No. 5,826,843 to Sturm requires threading of a rod through a hollow imitation banana, then engaging threads on the rod with a threaded fastener that is connected to the base of the hanger. Such assembly is time consuming and may require the use of tools. Further, if sold in one piece to the end user, disassembly and storage of the hanger become more difficult. It is desirable that, if assembly by the end user is required, assembly be as simple as possible. It is also desirable that a banana hanger be easy to disassemble, which enables the end user to easily move and store the hanger without it occupying as much space and with a lesser chance of breakage.

The present invention provides an easy to assemble banana hanger that does not require any additional tools or hardware. The invention provides a supporting member that slides onto a base member, such that no screws, nails, or other fasteners or tools are required by the end user to assemble the hanger. Due to the ease of assembly and disassembly, the amount of space required for moving and storage of the hanger and the likelihood of breakage of the hanger are reduced.

### SUMMARY OF THE INVENTION

The present invention relates to a banana hanger with a supporting member that slideably connects to a base member without any additional hardware or tools required. A base member made of wood or plastic, for example, has a dovetail-shaped notch cut into the top of it on one side. A supporting member has a connector piece that fits into the dovetail notch and is attached to one end of the supporting member. A hanging member extends from the end of the supporting member opposite the connector piece to hold bananas. The connector piece of the supporting member slides directly into the dovetail notch of the base member to complete assembly of the banana hanger.

### BRIEF DESCRIPTION OF THE FIGURES

FIG. 1 is a perspective view of the assembled banana hanger, using dashed lines to show how bananas are hung on the apparatus.

FIG. 2 is an exploded parts view, separately showing the base member, supporting member, hanging member, and connector piece.

FIG. 3 is a detailed top view of the base member of the apparatus.

FIG. 4 is a rear view of the base member.

FIG. 5 is a detailed side view of the supporting member and hanging member of the apparatus.

FIG. 6 is a bottom view of the supporting member.

FIG. 7 illustrates how the banana hanger is to be assembled.

### DETAILED DESCRIPTION OF THE INVENTION

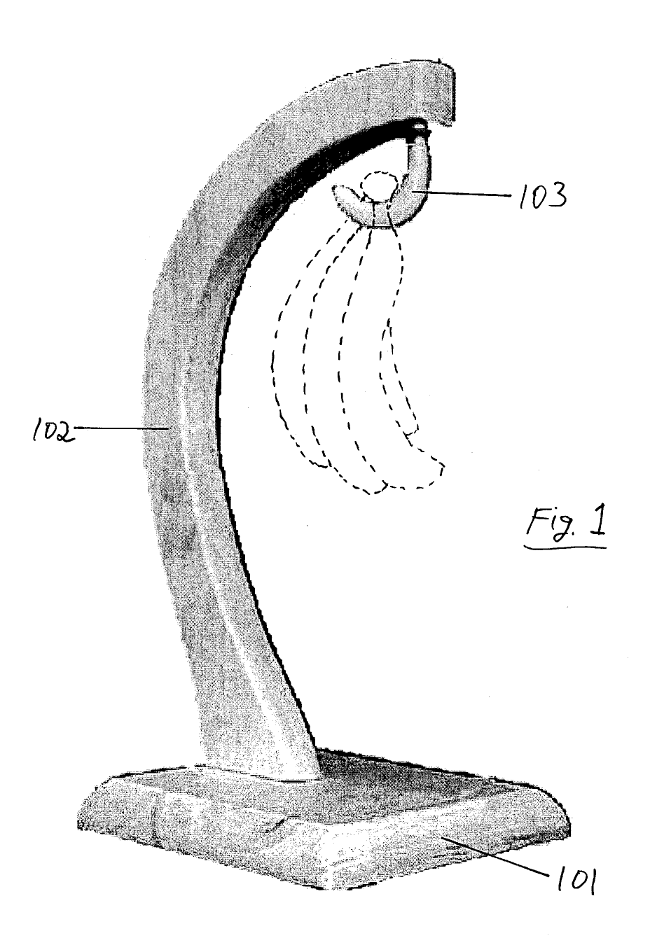

Referring to FIG. 1, a perspective view of the banana hanger is provided, having a base member 101, a supporting member 102, and a hanging member 103. The supporting member 102 connects to the base member 101, extends somewhat vertically from the base member 101 and bends toward the horizontal at the far or distal end where the hanging member 103 is attached.

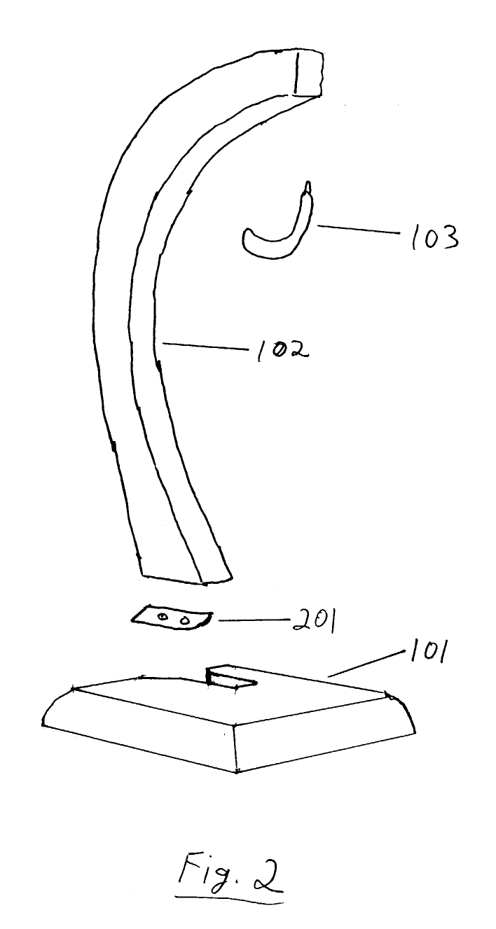

FIG. 2 provides an exploded parts view of the banana hanger, illustrating the individual members and the connector piece 201.

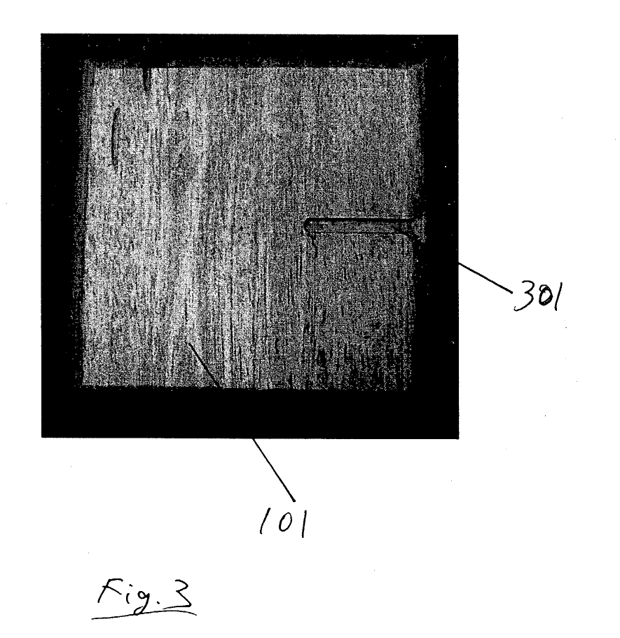

Referring to FIG. 3, a square wooden base member 101 is provided, however it is understood that the base member 101 can be other shapes and constructed of other materials, such as metal. A dovetail notch 301 is cut into the top of the base member 101 on one side.

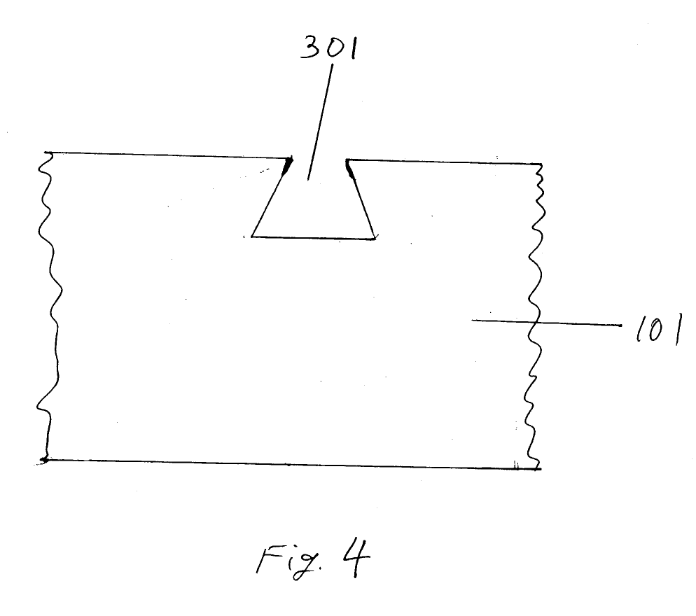

FIG. 4 shows a rear view of the base member 101 and notch 301.

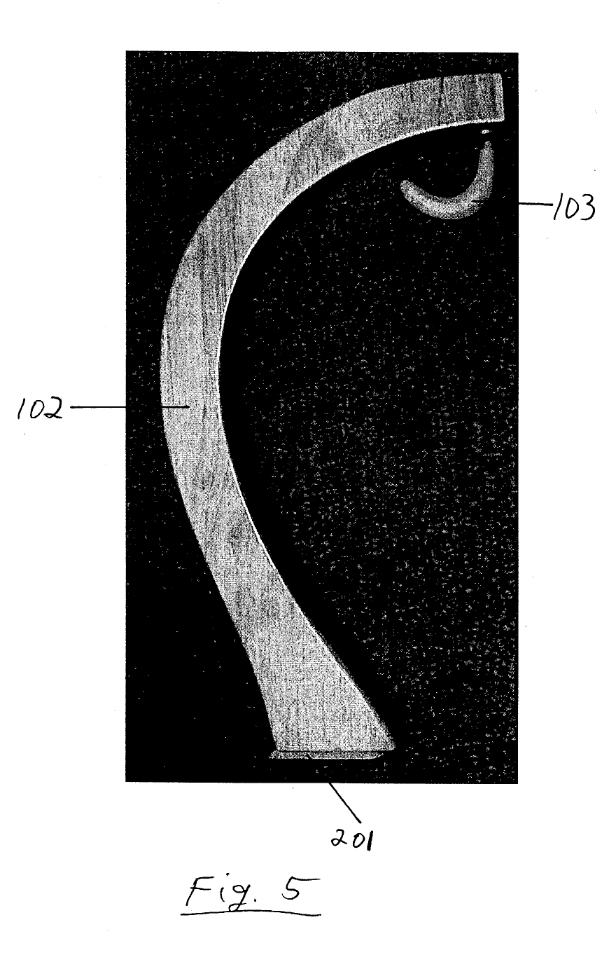

FIG. 5 shows a side view of an arc-shaped wooden supporting member 102 however it is understood that the supporting member 102 can be constructed of other materials, such as metal or plastic. A connector piece 201 is attached to the end of the supporting member 102 that is proximal to the base member 101 when the banana hanger is fully assembled. The connector piece 201 is shaped to fit into the dovetail notch 301 on the top of the base member 101 by sliding. The connector piece 201 is attached to the supporting member 102 by any method that will securely fasten it to the supporting member 102 such that when fully assembled, the banana hanger is tight and sturdy and there is little to no wobbling of the supporting member 102. Preferably, the connector piece 201 is constructed of plastic.

FIG. 5 also illustrates the hanging member 103 attached to one end of the supporting member 102. The hanging member 103 is attached to distal end of the supporting member 102 using any method to securely attach it such that the weight of a banana bunch will be supported. The hanging member 103 is arc shaped, so that bananas are suspended on the hanging member 103 and do not touch the surface on which the base member 101 rests. Preferably, the hanging member 103 is shaped like a banana. The hanging member 103 can be constructed of any material that will keep its shape and support bananas, for example wood or plastic. Preferably, the hanging member 103 is constructed of metal.

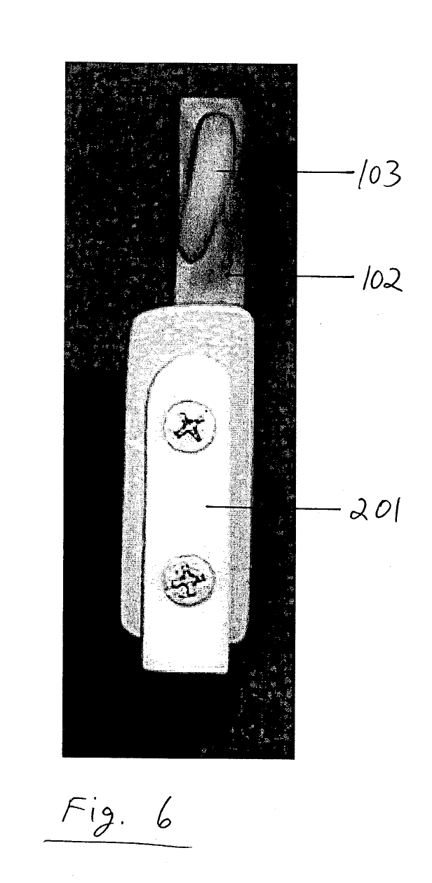

FIG. 6 shows a bottom view of the supporting member 102 with the hanging member 103 and attached connector piece 201. The connector piece 201 is shown attached using screws, but it is understood that any other method to securely attach the connector piece 201 to the supporting member 102 may be used.

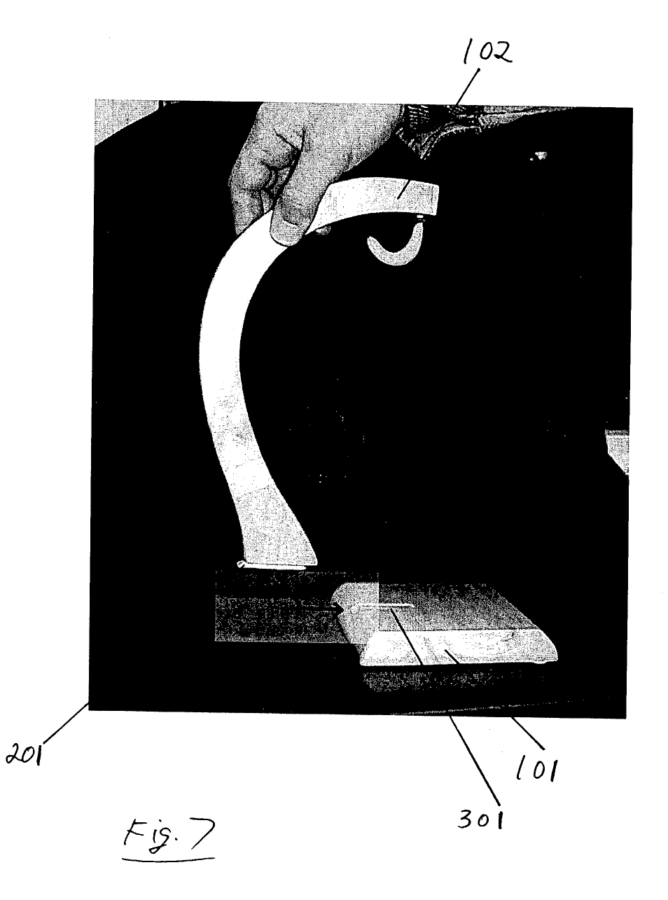

FIG. 7 illustrates how the banana hanger is assembled by sliding supporting member 102 into base member 101. The banana hanger is operably assembled by the end user by sliding the connector piece 201 into the dovetail notch 301 until the connector piece 201 comes into contact with the innermost edge of the dovetail notch 301. Once the connector piece 201 is securely in place and cannot move farther into the dovetail notch 301, the supporting member 102 and base member 101 are then properly positioned with respect to each other. In addition, the banana hanger is disassembled by sliding the supporting member 102 from the base member 101 to separate the two members.

The foregoing description provides only an exemplary embodiment of the present invention for the purposes of illustration and not limitation. It will be readily apparent to those skilled in the art that the embodiment described herein may be modified or revised in various ways without departing from the spirit and scope of the invention. The scope of the invention is to be measured by the appended claims.

What is claimed is:

1. A banana hanger comprising:
a base member having a dovetail notch therein;
a supporting member having a connector piece shaped to fit said dovetail notch and slideably connected to said base member wherein said connection is made without the need for additional tools or hardware, said supporting member comprising a proximal end at the point of connection to said base member, and a distal end; and
a hanging member attached at said distal end of said supporting member and extending downward and shaped to hold bananas.

2. The banana hanger of claim 1 wherein said supporting member extends essentially vertically at the proximal end from said base member and bends toward a horizontal position at the distal end.

3. The banana hanger of claim 1 wherein said banana hanger is comprised of wood.

4. The banana hanger of claim 1 wherein said connector piece is comprised of plastic, wood, or metal.

5. The banana hanger of claim 1 wherein said hanging member is shaped substantially like a banana.

6. The banana hanger of claim 1 wherein said additional tools or hardware comprises elements in addition to the base member and supporting member for assembly of said banana hanger.
